(19) United States
(12) Patent Application Publication
(10) Pub. No.: US 2020/0355963 A1
(43) Pub. Date: Nov. 12, 2020

(54) Backlight Module and Display Device with Backlight Module

(71) Applicant: FOSHAN NATIONSTAR OPTOELECTRONICS CO., LTD, Foshan (CN)

(72) Inventors: Fabo LIU, Foshan (CN); Danlei GONG, Foshan (CN); Zhonghai YAN, Foshan (CN); Junhua CHEN, Foshan (CN); Yihua TAN, Foshan (CN)

(21) Appl. No.: 16/870,900

(22) Filed: May 9, 2020

(30) Foreign Application Priority Data
May 9, 2019 (CN) 201910384931.9

(51) Int. Cl. G02F 1/13357

(52) U.S. Cl. CPC G02F 1/133603; G02F 1/133611; G02F 2001/133612; G02F 2001/133607; G02F 1/133606

(57) ABSTRACT

An embodiment of the present disclosure provides a backlight module and a display device with the backlight module. The backlight module includes a substrate and an LED luminous unit. There are a plurality of LED luminous units, the plurality of LED luminous units are arranged at intervals on the substrate in a length direction and width direction of the substrate, and a center distance A between two adjacent LED luminous units in the plurality of LED luminous units is more than or equal to 4 mm and less than or equal to 20 mm. The substrate includes a plurality of control regions, at least one LED luminous unit in the plurality of LED luminous units is arranged in each of the plurality of control regions, and the LED luminous unit in the each control region is independently controlled to regulate brightness or color of the each control region.

### CROSS-REFERENCE TO RELATED APPLICATION(S)

The present disclosure claims priority to Chinese Patent Application No. 201910384931.9, fled on May 9, 2019 and entitled “Backlight Module and Display Device with Backlight Module”, the contents of which are hereby incorporated by reference in its entirety.

### TECHNICAL FIELD

The present disclosure relates to a technical field of light-emitting diode (LED) lamp illustration, and particularly to a backlight module and a display device with the display device. A structure of the backlight module is mainly optimized and improved.

### BACKGROUND

A backlight module of a display device known to inventors can only increase or decrease whole backlight and does not implement regional brightness contrast. Consequently, brightness layer changes of a picture of the display device may not be really reflected, resulting in high picture distortion rate, weak dynamic sense and influence on a viewing experience of a user.

In the technical field of lighting, for further improving picture quality, particularly for the problem of poor contrast representation often attacked by the organic LED (OLED) group, the liquid crystal display (LCD) Industry starts extensively adopting a Local Dimming backlight source technology to realize a High Dynamic Range (HDR) function, thereby greatly improving the contrast representation to the level the same as that of OLED. How to effectively controlling the manufacturing cost to endow an LED display device with high economy and market competitiveness on the premise of improving the color saturation and brightness contrast of an LCD picture to meet a viewing experience of a user becomes a problem to be solved in the industry.

### SUMMARY

An embodiment of the present disclosure provides a backlight module and a display device with the backlight module, to solve the problems of poor color saturation and brightness contrast of an LCD picture of an LED display device and poor economy of the LED display device known to inventors.

Some embodiments of the present disclosure provide a backlight module, the backlight module includes a substrate and an LED luminous unit, wherein there are a plurality of LED luminous units, the plurality of LED luminous units are arranged at intervals on the substrate in a length direction and width direction of the substrate, and a center distance A between two adjacent LED luminous units in the plurality of light-emitting diode luminous units is more than or equal to 4 mm and less than or equal to 20 mm; and the substrate includes a plurality of control regions, at least one LED luminous unit in the plurality of light-emitting diode luminous units is arranged in each of the plurality of control regions, and each of the at least one LED luminous unit in the each of the plurality of control regions is independently controlled to regulate brightness or color of the each of the plurality of control regions.

In an exemplary embodiment, the number of the plurality of control regions is 500 to a 100,0000, the number of the at least one LED luminous unit in the each of the plurality of control regions is 1 to 100, all the LED luminous units in the each of the plurality of control regions are connected in series and/or in parallel, the backlight module further includes a driving structure configured to control the LED luminous units to be turned on/off or regulate brightness of the LED luminous units, and the each of the plurality of control regions is connected with the driving structure in parallel.

In an exemplary embodiment, each of the plurality of LED luminous units includes a blue LED device, and when a 10 mA current flows through the each of the plurality of LED luminous units, a luminous flux thereof is more than or equal to 0.2 lumen and less than or equal to 0.8 lumen; or each of the plurality of LED luminous units includes a white LED device, and when a 10 mA current flows through the each of the plurality of LED luminous units, a luminous flux thereof is more than or equal to 2 lumens and less than or equal to 6 lumens.

In an exemplary embodiment, a first center distance A1 between two adjacent LED luminous units of the plurality of light-emitting diode luminous units in the length direction of the substrate is more than or equal to a second center distance A2 between two adjacent LED luminous units of the plurality of light-emitting diode luminous units in the width direction of the substrate.

In an exemplary embodiment, the plurality of LED luminous units are distributed on the substrate in form of a matrix.

In an exemplary embodiment, a projection of each of the plurality of LED luminous units on the substrate is round, elliptical, rectangular or square.

Some embodiments of the present disclosure provide a display device, the display device includes the abovementioned backlight module and an optical module that are spaced, wherein the optical module includes an optical component layer, a conversion film layer and a liquid crystal glass layer.

In an exemplary embodiment, a spacing distance between the backlight module and the optical module is more than or equal to 1 mm and less than or equal to 12 mm.

In an exemplary embodiment, the optical component layer includes a diffuser plate, a diffusion film and a prism film, and the conversion film layer is a phosphor conversion film or a quantum dot conversion film.

In an exemplary embodiment, brightness of the display device is more than or equal to 250 nits and less than or equal to 2,000 nits.

With application of the technical solutions of some embodiments of the present disclosure, each part of the backlight module of an LED display device is structurally optimized, so that the LED display device achieves a picture display effect of OLED, and the greater advantage is that, compared with OLED, the display device provided in some embodiments of the present application is lower in cost and higher in economic performance.

In an embodiment, first, an arrangement manner for the plurality of LED luminous units of the backlight module is optimized in a manner that the plurality of LED luminous units are arranged at intervals on the substrate in the length direction and width direction of the substrate and the center distance A between two adjacent LED luminous units in the plurality of LED luminous units is more than or equal to 4 mm and less than or equal to 20 mm. In such a manner, a specific range of an important size parameter, i.e., a Pitch value, of the backlight module is limited, so that a preset luminous property is ensured for the backlight module, and on this premise, the number of the LED luminous units is greatly reduced, the production cost of the backlight module is reduced and the economy of the display device is further improved.

Second, the substrate is divided into the multiple control regions, at least one LED luminous unit is arranged in each control region, and the LED luminous unit in each control region is independently controlled to regulate the brightness or color of each control region. In such a manner, one or more of the multiple control regions is independently controlled, so that an obvious brightness contrast and high color saturation of a picture display on the display device are achieved, the display effect of the display device is improved, and improvement of a viewing experience of a user is further facilitated.

Therefore, according to the backlight module and the display device with the same in some embodiments of the present disclosure, the number of the LED luminous units is effectively controlled, and the economy is improved; and in addition, it is ensured that the picture display on the display device has a high color saturation and brightness contrast, and the practicability is improved.

### BRIEF DESCRIPTION OF THE DRAWINGS

The drawings forming a part of the present application in the specification are adopted to provide a further understanding to the present disclosure. Schematic embodiments of the present disclosure and descriptions thereof are adopted to explain the present disclosure and not intended to form improper limits to the present disclosure. In the drawings:

FIG. 1 is a schematic distribution diagram of a plurality of LED luminous units of a backlight module according to a first embodiment of the present disclosure;

FIG. 2 is a schematic distribution diagram of the plurality of LED luminous units of a backlight module according to a second embodiment of the present disclosure;

FIG. 3 is a schematic distribution diagram of the plurality of LED luminous units of a backlight module according to a third embodiment of the present disclosure; and

FIG. 4 is a structure diagram of a display device according to an exemplary embodiment of the present disclosure.

Herein, the drawings include the following reference signs:

1: backlight module; 10: substrate; 11: control region; 20: LED luminous unit; 2: optical module; 201: optical component layer; 202: conversion film layer; and 203: liquid crystal glass layer.

### DETAILED DESCRIPTION OF THE EMBODIMENTS

The technical solutions in embodiments of the present disclosure will be clearly and completely described below in combination with the drawings in the embodiments of the present disclosure. It is apparent that the described embodiments are only part of the embodiments of the present disclosure but not all of the embodiments. The following description of at least one exemplary embodiment is only illustrative actually, and is not used as any limitation for the present disclosure and the present application or use thereof. All other embodiments obtained by those of ordinary skill in the art based on the embodiments in the present disclosure without creative work shall fall within the scope of protection of the present disclosure.

For solving the problems of poor color saturation and brightness contrast of an LCD picture of a light-emitting diode (LED) display device and poor economy of the LED display device known to inventors, the present disclosure provides a backlight module and a display device. As shown in FIG. 4, the display device includes a backlight module 1 and an optical module 2 that are provided at intervals. The backlight module 1 is the abovementioned and undermentioned backlight module, and the optical module 2 includes an optical component layer 201, a conversion film layer 202 and a liquid crystal glass layer 203.

### Embodiment 1

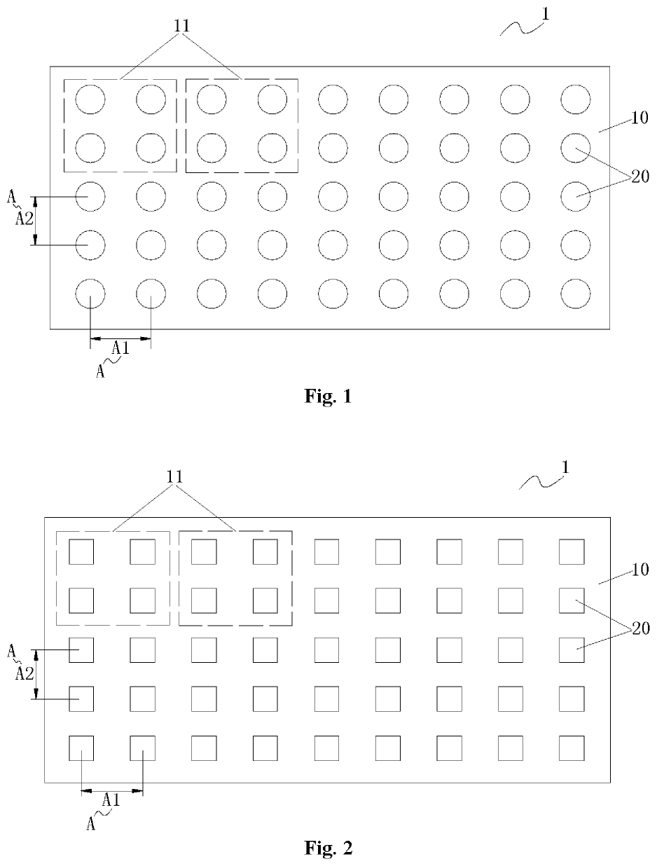

As shown in FIG. 1, a backlight module includes a substrate 10 and an LED luminous unit 20. There are a plurality of LED luminous units 20, the plurality of LED luminous units 20 are arranged at intervals on the substrate 10 in a length direction and width direction of the substrate 10, and a center distance A between two adjacent LED luminous units 20 in the plurality of LED luminous units 20 is more than or equal to 4 mm and less than or equal to 20 mm. The substrate 10 includes a plurality of control regions 11, at least one LED luminous unit 20 in the plurality of LED luminous units 20 is arranged in each control region 11, and the at least one LED luminous unit 20 in each control region 11 is independently controlled to regulate brightness or color of each control region 11.

Each part of the backlight module of an LED display device is structurally optimized, so that the LED display device achieves a picture display effect of OLED, and the greater advantage is that, compared with OLED, the display device provided in an embodiment of the present disclosure is lower in cost and higher in economic performance.

Specifically, first, an arrangement manner for the plurality of LED luminous units 20 of the backlight module 1 is optimized in a manner that the plurality of LED luminous units 20 are arranged at intervals on the substrate 10 in the length direction and width direction of the substrate 10 and the center distance A between two adjacent LED luminous units 20 in the plurality of LED luminous units 20 is more than or equal to 4 mm and less than or equal to 20 mm. In such a manner, a specific range of an important size parameter, i.e., a Pitch value, of the backlight module 1 is limited, so that a preset luminous property is ensured for the backlight module 1, and on this premise, the number of the plurality of LED luminous units 20 is greatly reduced, the production cost of the backlight module 1 is reduced and the economy of the display device is further improved.

Second, the substrate 10 is divided into the plurality of control regions 11, each of the plurality of control regions 11 is provided with at least one LED luminous unit 20 in the plurality of LED luminous units 20, and the at least one LED luminous unit 20 in each of the plurality of control regions 11 is independently controlled to regulate the brightness or color of the each of the plurality of control regions 11. In such a manner, one or more of the plurality of control regions 11 is independently controlled, so that an obvious brightness contrast and high color saturation of a picture display on the display device are achieved, the display effect of the display device is improved, and improvement of a viewing experience of a user is further facilitated.

To sum up, according to the backlight module and the display device with the same in some embodiments of the present disclosure, the number of the LED luminous units is effectively controlled, and the economy is improved; and in addition, it is ensured that the picture display on the display device has a high color saturation and brightness contrast, and the practicability is improved.

In an exemplary embodiment, the display device provided in the present disclosure adopts a Local Dimming backlight source technology or a single-point control backlight source technology to realize an HDR (high-dynamic range) function, the effect thereof is matched with a picture display effect of an OLED (i.e., Organic light-emitting diode) television, but its cost is only 40% to 70% of the OLED television. Compared with the OLED television capable of achieving a regional control effect, the display device in an embodiment of the present disclosure adopts the LED luminous units, adopts a design of series-parallel circuits between the multiple LED luminous units 20 and controls the plurality of control regions 11 through a driving structure. The plurality of control regions 11 independently controlled are formed to achieve the picture display effect of the OLED television.

For applying the displaying device to manufacturing of television screens of different grades and specifications, namely accurately controlling the color saturation and brightness contrast of the picture displayed on the display device to improve the practicability of the display device, in an embodiment, the number of the plurality of control regions 11 is 500 to a 100,0000, the number of the LED luminous unit 20 in each of the plurality of control regions 11 is 1 to 100, all the LED luminous units 20 in the each of the plurality of control regions 11 are connected in series and/or in parallel, the backlight module further includes a driving structure configured to control the LED luminous units 20 to be turned on/off or regulate brightness of the LED luminous units 20, and the each of the plurality of control regions 11 is connected with the driving structure in parallel.

In an exemplary embodiment of the present disclosure, the each of the plurality of LED luminous units 20 is a blue LED device, and when a 10 mA current flows through the LED luminous unit 20, a luminous flux thereof is more than or equal to 0.2 lumen and less than or equal to 0.8 lumen. When the 10 mA current flows through the blue LED device, the LED luminous unit 20 of which the luminous flux is in this range has an optimal luminous effect, so that the display device meets energy-saving performance, and meanwhile, the displayed picture has a good color saturation.

Of course, in an exemplary embodiment, that is not shown in the drawings, of the present disclosure, the each of the plurality of LED luminous units 20 is a white LED device, and when the 10 mA current flows through the LED luminous unit 20, the luminous flux thereof is more than or equal to 2 lumens and less than or equal to 6 lumens. Likewise, when the 10 mA current flows through the white LED device, the LED luminous unit 20 of which the luminous flux is in this range has an optimal luminous effect, so that the display device meets the energy-saving performance, and meanwhile, the displayed picture has a good color saturation.

Of course, in an exemplary embodiment, that is not shown in the drawings, of the present disclosure, the LED luminous unit 20 is an LED chip, and the LED chip is covered with a packaging colloid to protect the LED chip.

As shown in FIG. 1, a first center distance A1 between two adjacent LED luminous units 20 in the length direction of the substrate 10 is more than or equal to a second center distance A2 between two adjacent LED luminous units 20 in the width direction of the substrate 10. Such an arrangement manner for the LED luminous units 20 is more favorable for improving the luminous effect of the backlight module 1, so as to improve the display performance of the display device.

In an embodiment, the plurality of LED luminous units 20 are distributed on the substrate 10 in form of a matrix. Such an arrangement manner for the plurality of LED luminous units 20 is more favorable for machining and producing the backlight module 1 in batches to improve the manufacturing efficiency of the backlight module 1.

As shown in FIG. 1, a projection of the each of the plurality of LED luminous units 20 on the substrate 10 is round. That the projection of the each of the plurality of LED luminous units 20 on the substrate 10 is round is determined by a structural shape of the LED luminous unit 20. The LED luminous unit 20 wholly has a cylindrical contour, so that it is convenient to machining and production, a single LED luminous unit 20 has high luminous performance, and improvement of the display performance of the display device is facilitated.

### Embodiment 2

As shown in FIG. 2, the difference between the embodiment 2 and embodiment 1 is that the projection of the each of the plurality of LED luminous units 20 on the substrate 10 is square, and this is also determined by the structural shape of the each of the plurality of LED luminous units 20. A section of the whole LED luminous unit 20 is a square column, so that convenience is brought to machining and production, high luminous performance is achieved, the aesthetics of the appearance of the backlight module 1 is improved. It is facilitated for adjusting the luminous effect of the backlight module 1.

### Embodiment 3

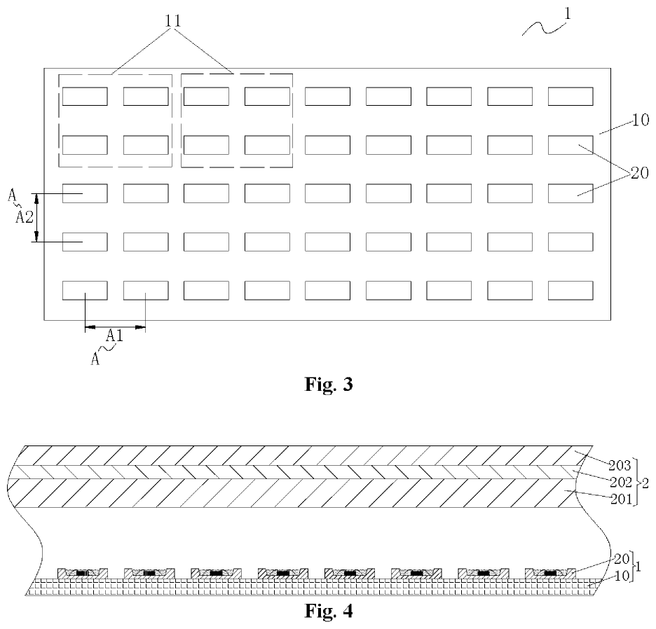

As shown in FIG. 3, the difference between the embodiment 3 and embodiment 1 is that the projection of the each of the plurality of LED luminous units 20 on the substrate 10 is rectangular, and this is also determined by the structural shape of the each of the plurality of LED luminous units 20. A section of the each LED luminous unit 20 as a whole is a rectangular column, so that convenience is brought to machining and production, high luminous performance is achieved, the aesthetics of the appearance of the backlight module 1 is improved, and control over the luminous effect of the backlight module 1 is facilitated.

Of course, in an embodiment, that is not shown in the drawings, of the present disclosure, the projection of the each of the plurality of LED luminous units 20 on the substrate 10 is elliptical.

According to the display device provided in some embodiments of the present disclosure, a spacing distance between the backlight module 1 and the optical module 2 is more than or equal to 1 mm and less than or equal to 12 mm. An Optical Distance (OD) value of the display device is optimized, so that improvement of the luminous performance of the backlight module 1 is facilitated, and the display performance of the display device is further improved.

As shown in FIG. 4, the optical component layer 201 includes a diffuser plate, a diffusion film and a prism film, and the conversion film layer 202 is a phosphor conversion film or a quantum dot conversion film. In some embodiments, the phosphor conversion film is a phosphor film including at least one of yellow phosphor, green phosphor and red phosphor.

It is to be noted that brightness of the display device machined and manufactured by use of the technical solutions provided in some embodiments of the present disclosure is more than or equal to 250 nits and less than or equal to 2,000 nits. A television manufactured by use of the display device can present high-definition 4K, 8K and 16K television pictures.

The above is only the preferred embodiment of the present disclosure and not intended to limit the present disclosure. For those skilled in the art, the present disclosure may have various modifications and variations. Any modifications, equivalent replacements, improvements and the like made within the spirit and principle of the present disclosure shall fall within the scope of protection of the present disclosure.

What is claimed is:

1. A backlight module, comprising:
a substrate; and
an light-emitting diode luminous unit, wherein there are a plurality of light-emitting diode luminous units, the plurality of light-emitting diode luminous units are arranged at intervals on the substrate in a length direction and width direction of the substrate, and a center distance A between two adjacent light-emitting diode luminous units in the plurality of light-emitting diode luminous units is more than or equal to 4 mm and less than or equal to 20 mm; and
the substrate comprises a plurality of control regions, at least one light-emitting diode luminous unit in the plurality of light-emitting diode luminous units is arranged in each of the plurality of control regions, and each of the at least one light-emitting diode luminous unit in the each of the plurality of control regions is independently controlled to regulate brightness or color of each control region.

2. The backlight module as claimed in claim 1, wherein the number of the plurality of control regions is 500 to a 100,0000, the number of the at least one light-emitting diode luminous unit in the each of the plurality of control regions is 1 to 100, all the LED luminous units in the each of the plurality of control regions are connected in series and/or in parallel, the backlight module further comprises a driving structure configured to control the light-emitting diode luminous units to be turned on/off or regulate brightness of the LED luminous units, and the each of the plurality of control regions is connected with the driving structure in parallel.

3. The backlight module as claimed in claim 1, wherein
each of the plurality of light-emitting diode luminous units comprises a blue light-emitting diode device, and when a 10 mA current flows through the each of the plurality of light-emitting diode luminous units, a luminous flux thereof is more than or equal to 0.2 lumen and less than or equal to 0.8 lumen; or
each of the light-emitting diode luminous units comprises a white light-emitting diode device, and when a 10 mA current flows through the each of the plurality of light-emitting diode luminous units, a luminous flux thereof is more than or equal to 2 lumens and less than or equal to 6 lumens.

4. The backlight module as claimed in claim 1, wherein a first center distance A1 between two adjacent light-emitting diode luminous units of the plurality of light-emitting diode luminous units in the length direction of the substrate is more than or equal to a second center distance A2 between two adjacent light-emitting diode luminous units of the plurality of light-emitting diode luminous units in the width direction of the substrate.

5. The backlight module as claimed in claim 1, wherein the plurality of light-emitting diode luminous units are distributed on the substrate in form of a matrix.

6. The backlight module as claimed in claim 1, wherein a projection of each of the plurality of light-emitting diode luminous units on the substrate is round, elliptical, rectangular or square.

7. A display device, comprising the backlight module as claimed in claim 1 and an optical module that are spaced, wherein the optical module comprises an optical component layer, a conversion film layer and a liquid crystal glass layer.

8. The display device as claimed in claim 7, wherein a spacing distance between the backlight module and the optical module is more than or equal to 1 mm and less than or equal to 12 mm.

9. The display device as claimed in claim 7, wherein the optical component layer comprises a diffuser plate, a diffusion film and a prism film, and the conversion film layer is a phosphor conversion film or a quantum dot conversion film.

10. The display device as claimed in claim 7, wherein brightness of the display device is more than or equal to 250 nits and less than or equal to 2,000 nits.

11. The display device as claimed in claim 7, wherein the number of the plurality of control regions is 500 to a 100,0000, the number of the at least one light-emitting diode luminous unit in the each of the plurality of control regions is 1 to 100, all the LED luminous units in the each of the plurality of control regions are connected in series and/or in parallel, the backlight module further comprises a driving structure configured to control the light-emitting diode luminous units to be turned on/off or regulate brightness of the LED luminous units, and the each of the plurality of control regions is connected with the driving structure in parallel.

12. The display device as claimed in claim 7, wherein
each of the plurality of light-emitting diode luminous units comprises a blue light-emitting diode device, and when a 10 mA current flows through the each of the plurality of light-emitting diode luminous units, a luminous flux thereof is more than or equal to 0.2 lumen and less than or equal to 0.8 lumen; or
each of the light-emitting diode luminous units comprises a white light-emitting diode device, and when a 10 mA current flows through the each of the plurality of light-emitting diode luminous units, a luminous flux thereof is more than or equal to 2 lumens and less than or equal to 6 lumens.

13. The display device as claimed in claim 7, wherein a first center distance A1 between two adjacent light-emitting diode luminous units of the plurality of light-emitting diode luminous units in the length direction of the substrate is more than or equal to a second center distance A2 between two adjacent light-emitting diode luminous units of the plurality of light-emitting diode luminous units in the width direction of the substrate.

14. The display device as claimed in claim 7, wherein the plurality of light-emitting diode luminous units are distributed on the substrate in form of a matrix.

15. The display device as claimed in claim 7, wherein a projection of each of the plurality of light-emitting diode luminous units on the substrate is round, elliptical, rectangular or square.
